(19) United States
(12) Patent Application Publication
(10) Pub. No.: US 2023/0347261 A1
(43) Pub. Date: Nov. 2, 2023

(54) Chromatography Solvent Supply With Tubing Arm For Positioning a Tubing End

(71) Applicant: Agilent Technologies, Inc., Santa Clara, CA (US)

(72) Inventors: Jan Lembcke, Waldbronn (DE); Dirk Arheidt, Waldbronn (DE); Gernot Klein, Waldbronn (DE)

(21) Appl. No.: 17/914,725

(22) PCT Filed: Mar. 16, 2021
(86) PCT No.: PCT/IB2021/052165

§ 371 Date: Sep. 26, 2022

(30) Foreign Application Priority Data
Mar. 27, 2020 (GB) 2004526.6

(51) Int. Cl. B01D 15/14; B01D 15/12; G01N 30/34

(52) U.S. Cl. CPC B01D 15/14; B01D 15/12; G01N 30/34

(57) ABSTRACT

A solvent supply for a chromatography system includes a mobile phase drive and a separation unit. The mobile phase drive is configured for driving a mobile phase through the separation unit, and the separation unit is configured for chromatographically separating compounds of a sample fluid in the mobile phase. The solvent supply comprises a tubing having a tubing end configured to couple to a solvent container to supply solvent contained in the solvent container via the tubing to the chromatography system. The tubing is configured in a flexible manner to allow the tubing end to be movable. A tubing arm supports the tubing to allow positioning the tubing end into a first resting position, such that the tubing end is at least substantially held in position and distantly situated beyond a reference to prevent physical contact with the reference.

### BACKGROUND ART

The present invention relates to a solvent supply for chromatographic sample separation.

For liquid separation in a chromatography system, a mobile phase comprising a sample fluid (e.g. a chemical or biological mixture) with compounds to be separated is driven through a stationary phase (such as a chromatographic column packing), thus separating different compounds of the sample fluid which may then be identified. The term compound, as used herein, shall cover compounds which might comprise one or more different components.

The mobile phase, typically comprised of one or more solvents, is pumped under high-pressure typically through a chromatographic column containing packing medium (also referred to as packing material or stationary phase). As the sample is carried through the column by the liquid flow, the different compounds, each one having a different affinity to the packing medium, move through the column at different speeds. Those compounds having greater affinity for the stationary phase move more slowly through the column than those having less affinity, and this speed differential results in the compounds being separated from one another as they pass through the column. The stationary phase is subject to a mechanical force generated in particular by a hydraulic pump that pumps the mobile phase usually from an upstream connection of the column to a downstream connection of the column. As a result of flow, depending on the physical properties of the stationary phase and the mobile phase, a relatively high-pressure drop is generated across the column.

The mobile phase with the separated compounds exits the column and passes through a detector, which registers and/or identifies the molecules, for example by spectrophotometric absorbance measurements. A two-dimensional plot of the detector measurements against elution time or volume, known as a chromatogram, may be made, and from the chromatogram the compounds may be identified. For each compound, the chromatogram displays a separate curve feature also designated as a “peak”.

In preparative chromatography systems, a liquid as the mobile phase is provided usually at a controlled flow rate (e. g. in the range of 1 mL/min to thousands of mL/min, e.g. in analytical scale preparative LC in the range of 1-5 mL/min and preparative scale in the range of 4-200 mL/min) and at pressure in the range of tens to hundreds bar, e.g. 20-600 bar.

In high performance liquid chromatography (HPLC), a liquid as the mobile phase has to be provided usually at a very controlled flow rate (e. g. in the range of microliters to milliliters per minute) and at high-pressure (typically 20-100 MPa, 200-1000 bar, and beyond up to currently 200 MPa, 2000 bar) at which compressibility of the liquid becomes noticeable.

In preparative chromatography systems used for chromatography fluidically separating samples at a larger volume, typically in the range of 0.1 mL to tens of mL, there often is a need for analysing a smaller volume of such sample prior to running the separation of the larger volume (e.g. in the sense of an “analytical scouting run”). For such purpose, an analytical chromatography system may be used for chromatographically separating smaller sample volumes, typically in the range of 10 uL-50 ul. Such analytical chromatography system may be an HPLC system.

When changing bottles containing solvent to provide the mobile phase, the workflow for an operator typically is to take a solvent bottle off a solvent bottle tray, open a screw cap, pull out a solvent tubing e.g. with an attached solvent filter, put the solvent bottle aside, open the new solvent bottle, put in the solvent tubing with filter, close the bottle with the screw cap, and finally close the previous solvent bottle with a screw cap. To do such workflow properly, the operator needs to have “more than two hands” or has to put the solvent tubing with attached filter somewhere. When the solvent tubing hangs free, solvent might drip off the filter e.g. onto the LC system, the lab floor, the shelf, et cetera. When putting the solvent tubing in the solvent tray, the filter might get contaminated by dust, particles, et cetera and may then contaminate the new solvent or mobile phase.

### DISCLOSURE

It is an object of the invention to provide an improved solvent supply, preferably for chromatographic sample separation. The object is solved by the independent claims. Further embodiments are shown by the dependent claims.

In one embodiment, a solvent supply is provided for a chromatography system comprising a mobile phase drive and a separation unit, wherein the mobile phase drive is configured for driving a mobile phase through the separation unit, and the separation unit is configured for chromatographically separating compounds of a sample fluid in the mobile phase. The solvent supply comprises a tubing having a tubing end configured to couple to a solvent container in order to supply solvent contained in the solvent container via the tubing to the chromatography system, wherein the tubing is configured in a flexible manner in order to allow the tubing end to be movable. A tubing arm is supporting the tubing in order to allow positioning the tubing end into a first resting position wherein the tubing end is at least substantially held in position and being distantly situated beyond a reference in order to prevent physical contact to the reference. This allows to avoid or at least reduce potential contamination to or by the solvent.

In one embodiment, the reference is at least one of a group of: the solvent container; the tubing; a container base configured to support the solvent container when being positioned on the container base; and a waste sink configured to receive solvent dripping from the tubing end.

In one embodiment, the tubing arm is configured to at least substantially maintain a spatial position of the tubing end in the first resting position.

In one embodiment, in the first resting position, the tubing is distantly situated beyond the reference and prevented from physical contact thereto.

In one embodiment, the tubing can be spirally coiled. The tubing can be flexible.

The tubing end may comprise a coupling head configured to removably couple to an opening of the solvent container in order to attach the coupling head to the opening of the solvent container, preferably by at least one of: screwing, bayonet-coupling, plugging (e.g. opening into the coupling head), clamping or the like.

The tubing end may comprise a tubing opening having an open end to be inserted into the solvent container in order to allow aspirating solvent contained in the solvent container into the tubing.

In one embodiment, the tubing arm comprises an upright part extending upright (e.g. with respect to the container base) and being configured to guide a first portion of the tubing (e.g. to extend beyond the container base), wherein a second portion of the tubing comprising the tubing end is extending from and not being supported by the upright part, so that at least the second portion of the tubing is flexibly movable.

In one embodiment, the solvent supply comprises an elastic member supporting and/or guiding at least a portion of the tubing in order to allow that portion of the tubing to be flexibly movable.

The elastic member may be part of the tubing arm, preferably comprising at least one of: a spring element, a flexible outer tubing surrounding at least a portion of the tubing, a reinforcing element (like a wire), a strip or a coil, and preferably being attached to or surrounding at least a portion of the tubing and further preferably being plastically deformable.

In one embodiment, the tubing arm is configured in a balanced manner allowing the tubing end to remain in a position within a range of arbitrary positions after the tubing end has been positioned (manually or e.g. motor driven) into that position.

In one embodiment, the tubing arm is configured in an elastic manner allowing the tubing end to return into a given home position when being freely movable.

In one embodiment, a velocity of movement of the tubing arm for returning into the given home position is controlled and/or fixed to appropriate value.

In one embodiment, a path of movement of the tubing arm for returning into the given home position is predefined.

In one embodiment, the home position is situated beyond a waste sink in order to receive any dripping from the tubing end into the waste sink.

In one embodiment, the solvent supply comprises a plurality of tubings. One or more of the tubings may be supported by a respective tubing arm. Alternatively or in addition, one or more of the tubings may be supported by a common tubing arm.

In an embodiment, a separation system is provided for separating compounds of a sample fluid in a mobile phase. The fluid separation system comprises a mobile phase drive, preferably a pumping system, configured to drive the mobile phase through the fluid separation system, a separation unit, preferably a chromatographic column, configured for separating compounds of the sample fluid in the mobile phase, and a solvent supply according to any of the aforementioned embodiments.

In one embodiment, the separation system further comprises at least one of a sample dispatcher configured to introduce the sample fluid into the mobile phase, a detector configured to detect separated compounds of the sample fluid, a collection unit configured to collect separated compounds of the sample fluid, a data processing unit configured to process data received from the fluid separation system, a degassing apparatus for degassing the mobile phase.

In one embodiment, the separation system is a liquid chromatography system, wherein the sample fluid is a sample liquid, the mobile phase is comprised of one or more liquid solvents, and the separation unit is a chromatographic column configured for separating liquid compounds of the sample liquid in the mobile phase.

Embodiments of the present invention might be embodied based on most conventionally available HPLC systems, such as the Agilent 1220, 1260 and 1290 Infinity II LC Series (provided by the applicant Agilent Technologies).

The separating device preferably comprises a chromatographic column providing the stationary phase. The column might be a glass, metal, ceramic or a composite material tube (e.g. with a diameter from 50 μm to 5 mm and a length of 1 cm to 1 m) or a microfluidic column (as disclosed e.g. in EP 1577012 A1 or the Agilent 1200 Series HPLC-Chip/MS System provided by the applicant Agilent Technologies). The individual components are retained by the stationary phase differently and separate from each other while they are propagating at different speeds through the column with the eluent. At the end of the column they elute at least partly separated from each other. During the entire chromatography process the eluent might be also collected in a series of fractions. The stationary phase or adsorbent in column chromatography usually is a solid material. The most common stationary phase for column chromatography is silica gel, followed by alumina.

The mobile phase (or eluent) can be either a pure solvent or a mixture of different solvents. It can also contain additives, i.e. be a solution of the said additives in a solvent or a mixture of solvents. It can be chosen e.g. to adjust the retention of the compounds of interest and/or the amount of mobile phase to run the chromatography. The mobile phase can also be chosen so that the different compounds can be separated effectively. The mobile phase might comprise an organic solvent like e.g. methanol or acetonitrile, often diluted with water. For gradient operation water and organic solvent is delivered in separate containers, from which the gradient pump delivers a programmed blend to the system. Other commonly used solvents may be isopropanol, THF, hexane, ethanol and/or any combination thereof or any combination of these with aforementioned solvents.

The sample fluid might comprise any type of process liquid, natural sample like juice, body fluids like plasma or it may be the result of a reaction like from a fermentation broth.

The fluid is preferably a liquid but may also be or comprise a gas and/or a supercritical fluid (as e.g. used in supercritical fluid chromatography—SFC—as disclosed e.g. in U.S. Pat. No. 4,982,597 A).

The pressure in the mobile phase might range from 2-200 MPa (20 to 2000 bar), in particular 10-150 MPa (100 to 1500 bar), and more particular 50-130 MPa (500 to 1300 bar).

The HPLC system might further comprise a detector for detecting separated compounds of the sample fluid, a fractionating unit for outputting separated compounds of the sample fluid, or any combination thereof. Further details of HPLC system are disclosed with respect to the aforementioned Agilent HPLC series, provided by the applicant Agilent Technologies.

### BRIEF DESCRIPTION OF DRAWINGS

Other objects and many of the attendant advantages of embodiments of the present invention will be readily appreciated and become better understood by reference to the following more detailed description of embodiments in connection with the accompanied drawings. Features that are substantially or functionally equal or similar will be referred to by the same reference signs.

FIG. 1 illustrates a liquid chromatography system according to an exemplary embodiment.

FIG. 2 illustrates an embodiment of a solvent supply 200 according to the present invention.

FIG. 3 shows an alternative embodiment of the tubing arm 280 which is embodied by a movable spring-loaded lever construction.

FIGS. 4-6 show alternative embodiments of the tubing arm 280.

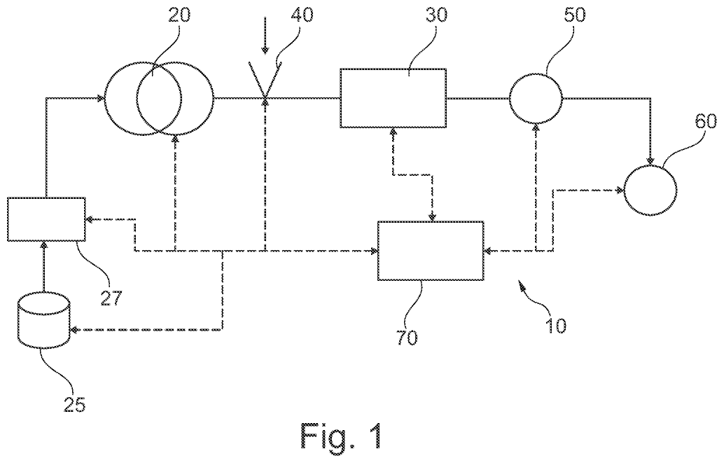

Referring now in greater detail to the drawings, FIG. 1 depicts a general schematic of a liquid separation system 10. A mobile phase drive 20 (such as a pump) receives a mobile phase from a solvent supply 25, typically via a degasser 27, which degases the mobile phase and thus reduces the amount of dissolved gases in it. The mobile phase drive 20 drives the mobile phase through a separating device 30 (such as a chromatographic column). A sample injector 40 (also referred to as sample introduction apparatus, sample dispatcher, etc.) is provided between the mobile phase drive 20 and the separating device 30 in order to subject or add (often referred to as sample introduction) portions of one or more sample fluids into the flow of a mobile phase. The separating device 30 is adapted for separating compounds of the sample fluid, e.g. a liquid. A detector 50 is provided for detecting separated compounds of the sample fluid. A fractionating unit 60 can be provided for outputting separated compounds of sample fluid. In one embodiment, at least parts of the sample injector 40 and the fractionating unit 60 can be combined, e.g. in the sense that some common hardware is used as applied by both of the sample injector 40 and the fractionating unit 60.

The separating device 30 may comprise a stationary phase configured for separating compounds of the sample fluid. Alternatively, the separating device 30 may be based on a different separation principle (e.g. field flow fractionation).

While the mobile phase can be comprised of one solvent only, it may also be mixed of plurality of solvents. Such mixing might be a low pressure mixing and provided upstream of the mobile phase drive 20, so that the mobile phase drive 20 already receives and pumps the mixed solvents as the mobile phase. Alternatively, the mobile phase drive 20 might be comprised of plural individual pumping units, with plural of the pumping units each receiving and pumping a different solvent or mixture, so that the mixing of the mobile phase (as received by the separating device 30) occurs at high pressure and downstream of the mobile phase drive 20 (or as part thereof). The composition (mixture) of the mobile phase may be kept constant over time, the so-called isocratic mode, or varied over time, the so-called gradient mode.

A data processing unit 70, which can be a conventional PC or workstation, might be coupled (as indicated by the dotted arrows) to one or more of the devices in the liquid separation system 10 in order to receive information and/or control operation.

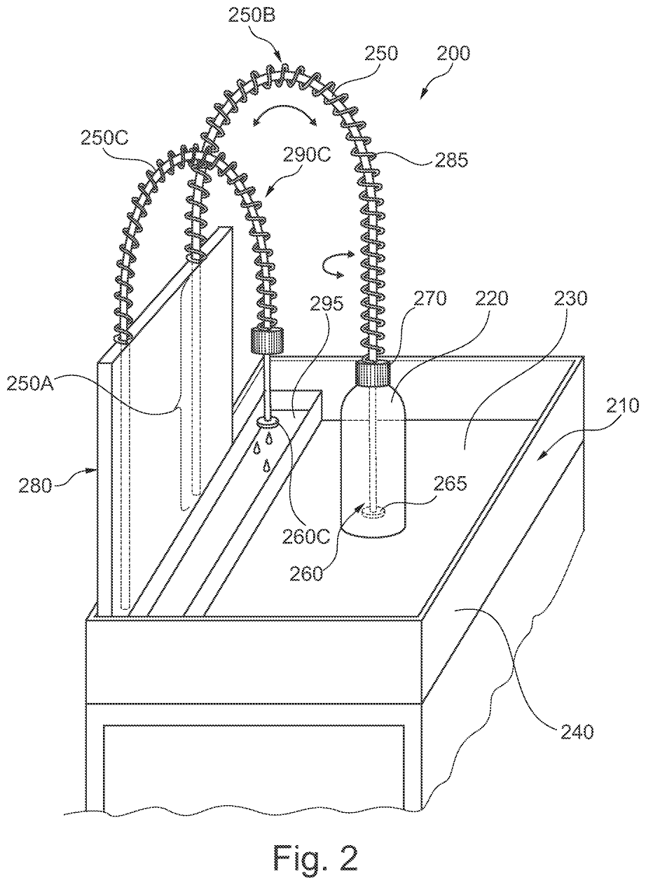

FIG. 2 illustrates an embodiment of a solvent supply 200 according to the present invention. The solvent supply 200 comprises a solvent cabinet 210 into which one or more solvent bottles 220 can be placed (with a single solvent bottle 220 exemplary represented in FIG. 2). In the shown embodiment, the solvent cabinet 210 has a base plate 230, onto which the one or more solvent bottles 220 can be placed, and a lateral bordering 240 to maintain the solvent bottles 220 within the solvent cabinet 210. It is clear that the lateral bordering 240 needs not be provided on all lateral sides to the base plate 230, for example if one or more sides to the base plate 230 are otherwise secured against an unwanted falling down of solvent bottles 220. It is also clear that in addition to or instead of the lateral bordering 240, other measures for securing one or more of the solvent bottles 220 within the solvent cabinet 210 may be provided, such as individual bottle holders for individually securing and holding in place a respective solvent bottle 220, as readily known in the art.

In order to supply solvent contained in the solvent bottle 220 to the liquid separation system 10, e.g. towards the mobile phase drive 20, a tubing 250 is provided. The tubing 250 has a tubing end 260 configured to couple to a respective solvent bottle 220. In the shown embodiment, the tubing end 260 has a filter element 265 which can be inserted into the solvent bottle 220, thus allowing to aspirate solvent contained from within the solvent bottle 220, as readily known in the art. It is clear that the tubing end 260, e.g. the filter element 265, may be positioned within the solvent bottle 220 as close as possible to a bottom of the solvent bottle 220 in order to allow removal of as much as possible solvent.

In the exemplary embodiment of FIG. 2, the solvent supply 200 shall comprise two tubings 250 and 250′ allowing to couple two different solvent bottles 220 (with only one solvent bottle 220 being shown in FIG. 2). The two tubings 250 and 250′ can be embodied substantially identical but may also be provided with different features, e.g. different types of caps 270 allowing to couple to different types of solvent bottles 220. In the embodiment of FIG. 2, the tubing arm 280 holds the two tubings 250 and 250′ slightly distanced but in parallel neighbouring each other. It is clear that a respective tubing arm 280 may be provided to support each respective tubing 250 and/or that more than two tubings 250 may be provided dependent on the respective application. Further, it is clear that only a single tubing 250 (together with a single tubing arm 280) or more than two tubings 250 (with respective and/or common tubing arms 280) may be applied accordingly dependent on the respective requirements and application.

The tubing 250 may further comprise a cap 270 which can be affixed to the solvent bottle 220, e.g. in order to close the solvent bottle 220 and/or to avoid evaporation of solvent from the solvent bottle 220. Such cap 270 may be screwed on or otherwise suffixed to an opening of the solvent bottle 220, typically at the solvent head.

A tubing arm 280 is further provided and supporting at least a portion of the tubing 250, in the embodiment of FIG. 2 a portion 250A. A remaining portion 250B of the tubing 250 extending beyond the portion 250A is substantially freely movable. In the embodiment of FIG. 2, portion 250B of the tubing 250 is further surrounded by a spiral coil 285 to flexibly support the tubing 250.

As apparent from FIG. 2, the tubing arm 280 is extending upwardly (e.g. with respect to the solvent cabinet 210), and also the spiral coil 285 is providing a flexible but sufficient mechanical support, so that the tubing 250 and in particular the tubing end 260 will be securely held beyond the solvent cabinet 210 if the tubing 250 is not coupled to a respective solvent container 220 and “left alone”, e.g. into a resting position 290′ as indicated for the second tubing 250′. In the embodiment shown, the tubing end 260′ of the second tubing 250′ is held in position in the resting position 290′ distantly situated beyond a waste sink 295, so that any liquid spilling off from the tubing end 260′ will drip down into the waste sink 295.

In the embodiment of FIG. 2, when the tubing 250 will be displaced from coupling to the solvent bottle 220, e.g. by unscrewing cap 270, the tubing arm 280 together with the spiral coil 285 will provide a “return force” to return the tubing end 260′ into the resting position 290′ situated beyond the waste sink 295. In other words, the tubing 250 together with the tubing arm 280 is configured to force the tubing 250 (or respective tubing 250′) and in particular the tubing end 260 (or respective tubing end 260′) into the resting position 290 (or respective resting position 290′) unless the tubing 250/250′ is not (e.g. manually or driven by motor) forced into another position (e.g. to couple to a respective solvent bottle 220). The resting position 290/290′ represents a “safe position” wherein in particular the tubing end 260/260′ is securely distanced from touching any other component, such as the base plate 230, so that contamination as resulting from such contact/touching with other components can be avoided when being in the resting position 290/290′. Also, e.g. by situating the resting position 290/290′ beyond the waste sink 295, it can be assured that any droplets dripping from the respective tubing 250/250′ can be securely removed and may not contaminate other components. This may increase safety and usability and may prevent contamination of the solvents as well as the surrounding area.

It is clear that the tubing arm 280 can be configured to assume any other resting position 290/290′ than as exemplary illustrated in FIG. 2, as long as contamination resulting from physical contact e.g. by the tubing end 260 with any other component is avoided. Also, the tubing arm 280 may be configured to allow a plurality of such resting positions 290, each being distantly situated beyond a respective reference (e.g. the solvent cabinet 210, the tubing 250 itself, or any other part of the HPLC system 10 or its environment) in order to prevent physical contact to such reference.

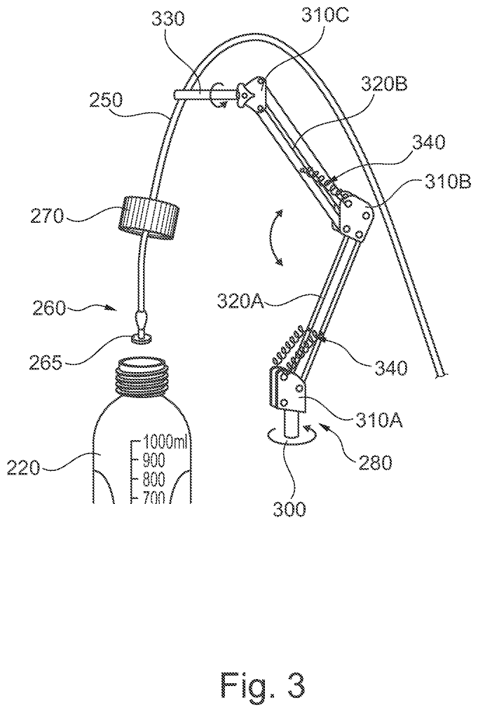

FIG. 3 shows an alternative embodiment of the tubing arm 280 which is embodied by a movable spring-loaded lever construction. In the exemplary embodiment of FIG. 3, the tubing arm 280 can be affixed via a plate 300 e.g. to the base plate 230 of the solvent cabinet 210 or wherever appropriate. One or more hinges 310 (three hinges 310A, 310B, 310C in the embodiment of FIG. 3) together with one or more arms 320 (two double arms 320A and 320B in the embodiment of FIG. 3) provide a flexibly movable support allowing to position the tubing 250. In the exemplary embodiment of FIG. 3, the tubing arm 280 coupled to and holds the tubing 250 by a grapping element 330 which again may be rotatably coupled to hinge 310C. The various directions of movement of the tubing arm 280 are indicated by respective arrows. Spring elements 340 may be applied coupling between respective arms 320 and hinges 310 in order to support mobility of the tubing arm 280.

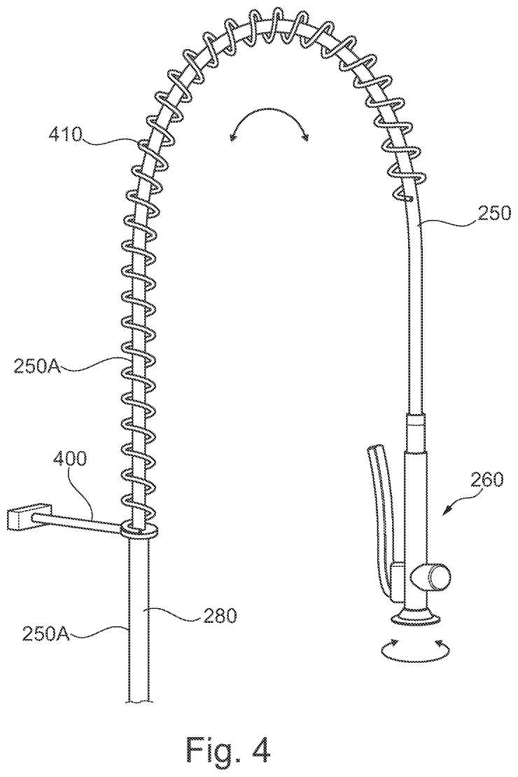

FIG. 4 shows an alternative embodiment of the tubing arm 280. The tubing arm 280 is configured as a tubing surrounding and holding the portion 250A to extend in an upwards direction. The tubing arm 280 may be affixed to a side component, e.g. the lateral boarding 240, as indicated by holding element 400. Similar to the spiral coil 285 in FIG. 2, at least a portion of the tubing 250 is surrounded by a spiral coil 410 providing flexible mechanical support to the tubing 250. The tubing end 260 is provided with a lever supported closing mechanism to support a fast coupling to a respective solvent container 220 (not shown in FIG. 4).

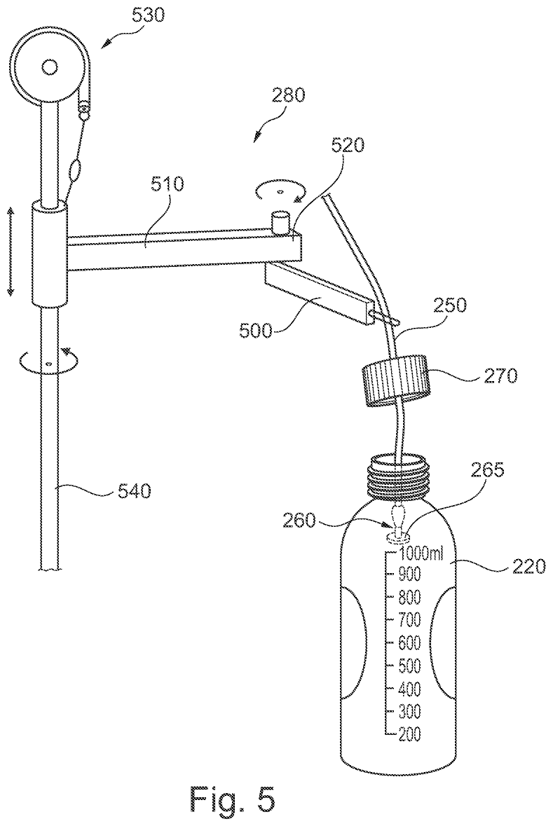

FIG. 5 shows a further alternative embodiment of the tubing arm 280. A pivotable arm 500 is grapping and holding the tubing 250. The pivotable arm 500 is coupled to an extension arm 510 via a hinge 520. The extension arm 510 can be moved in Z-direction (i.e. in a direction upwards with respect e.g. the base plate 230) by means of spring-loaded mechanism 530 allowing to move the extension arm 510 along a rod 540.

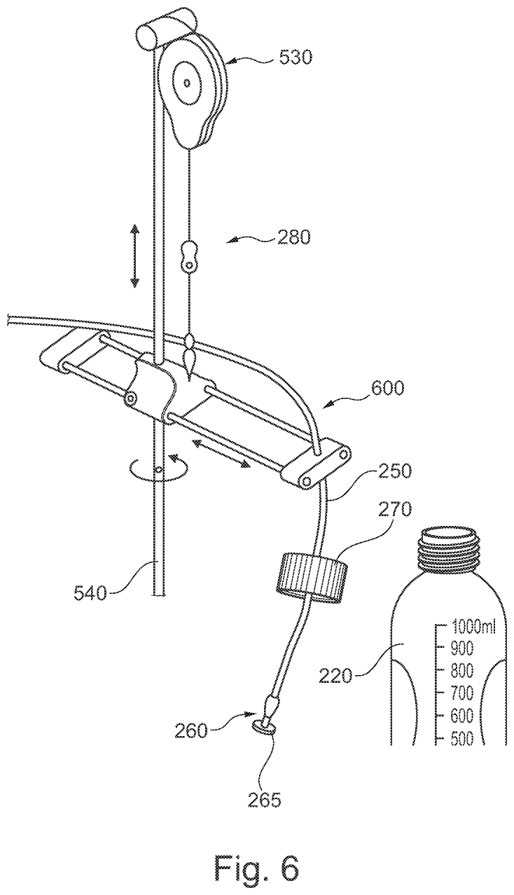

FIG. 6 shows another alternative embodiment of the tubing arm 280 similar to the embodiment of FIG. 5. The tubing arm 280 couples to and holds the tubing 250 by an arm 600 configured to extend and being movable substantially perpendicular to the rod 540.

The different directions of movement are indicated by respective arrows in the FIGS. 2-6.

In the embodiments of FIGS. 3, 5 and 6, the tubing arm 280 allows assuming a plurality and virtually arbitrarily many resting positions for the tubing 250 and/or tubing end 260, in contrast to the embodiment of FIGS. 2 and 4 where the resting position 290 is substantially defined by the return forces provided e.g. by spring coils 285 and 410. This allows a user of the embodiments of FIGS. 3, 5, 6 to deliberately position the tubing 250 and/or the tubing end 260 to wherever appropriate but distantly apart from and avoiding physical contact to other components thus avoiding or at least reducing potential contamination.

Further, the embodiments of FIGS. 3, 5, 6 allow providing the tubing arm 280 in a balanced manner, so that the tubing end 260 will remain in each arbitrary position (of course within a certain range of positions defined by the mechanical construction). In other words, in such balanced configuration the tubing arm 280 will maintain the tubing end 260 to remain in an (e.g. user-) selected spatial position without applying a force to deviate from such selected spatial position.

1. A solvent supply for a chromatographic separation system comprising a mobile phase drive and a separation unit, wherein the mobile phase drive is configured for driving a mobile phase through the separation unit, and the separation unit is configured for chromatographically separating compounds of a sample fluid in the mobile phase, the solvent supply comprising:
a tubing having a tubing end configured to couple to a solvent container in order to supply solvent contained in the solvent container via the tubing to the chromatography system, wherein the tubing is configured in a flexible manner in order to allow the tubing end to be movable; and
a tubing arm supporting the tubing in order to allow positioning the tubing end into a first resting position wherein the tubing end is at least substantially held in position and being distantly situated beyond a reference in order to prevent physical contact to the reference.

2. The solvent supply of claim 1, wherein the reference is at least one selected from the group consisting of:
the solvent container;
the tubing;
a container base configured to support the solvent container when being positioned on the container base; and
a waste sink configured to receive solvent dripping from the tubing end.

3. The solvent supply of claim 1, wherein the tubing arm is configured to at least substantially maintain a spatial position of the tubing end in the first resting position.

4. The solvent supply of claim 1, wherein in the first resting position, the tubing is distantly situated beyond the reference and prevented from physical contact thereto.

5. The solvent supply of claim 1, comprising at least one of:
the tubing is spirally coiled;
the tubing is flexible;
the tubing end comprises a coupling head configured to removably couple to an opening of the solvent container in order to attach the coupling head to the opening of the solvent container;
the tubing end comprises a tubing opening having an open end to be inserted into the solvent container in order to allow aspirating solvent contained in the solvent container into the tubing.

6. The solvent supply of claim 1, wherein:
the tubing arm comprises an upright part extending upright and being configured to guide a first portion of the tubing; and
wherein a second portion of the tubing comprising the tubing end is extending from and not being supported by the upright part, so that at least the second portion of the tubing is flexibly movable.

7. The solvent supply of claim 1, comprising an elastic member supporting and/or guiding at least a portion of the tubing in order to allow that portion of the tubing to be flexibly movable.

8. The solvent supply claim 7, wherein the elastic member is part of the tubing arm, and further comprising at least one of:
the elastic member comprises at least one of: a spring element, a flexible outer tubing surrounding at least a portion of the tubing, a reinforcing element, a strip or a coil;
the elastic member is attached to or surrounding at least a portion of the tubing;
the elastic member is plastically deformable.

9. The solvent supply of claim 1, wherein the tubing arm is configured in a balanced manner allowing the tubing end to remain in a position within a range of arbitrary positions after the tubing and has been positioned into that position.

10. The solvent supply of claim 1, wherein the tubing arm is configured in an elastic manner allowing the tubing end to return into a given home position when being freely movable.

11. The solvent supply claim 10, comprising at least one of:
a velocity of movement of the tubing arm for returning into the given home position is controlled and/or fixed to appropriate value;
a path of movement of the tubing arm for returning into the given home position is predefined;
the home position is situated beyond a waste sink in order to receive any dripping from the tubing end into the waste sink.

12. A chromatographic separation system for separating compounds of a sample fluid in a mobile phase, the chromatographic separation system comprising:
the solvent supply of claim 1;
a mobile phase drive configured to drive the mobile phase through the chromatographic separation system; and
a separation unit configured for separating compounds of the sample fluid in the mobile phase.

13. The chromatographic separation system of claim 12, further comprising at least one of:
a sample dispatcher configured to introduce the sample fluid into the mobile phase;
a detector configured to detect separated compounds of the sample fluid;
a collection unit configured to collect separated compounds of the sample fluid;
a data processing unit configured to process data received from the chromatographic separation system;
a degassing apparatus for degassing the mobile phase.

14. The chromatographic separation system of claim 12, wherein the chromatographic separation system is a liquid chromatography system, the sample fluid is a sample liquid, the mobile phase comprises one or more liquid solvents, and the separation unit is a chromatographic column configured for separating liquid compounds of the sample liquid in the mobile phase.
